(19) United States
(12) Patent Application Publication
(10) Pub. No.: US 2020/0037811 A1
(43) Pub. Date: Feb. 6, 2020

(54) AUTOMATED COFFEE BREWING SYSTEM AND METHODS

(71) Applicant: Automated Coffee Systems LLC, Janesville, WI (US)

(72) Inventor: DAVID HEFTY, Janesville, WI (US)

(73) Assignee: Automated Coffee Systems LLC, Janesville, WI (US)

(21) Appl. No.: 16/531,337

(22) Filed: Aug. 5, 2019

Related U.S. Application Data
(60) Provisional application No. 62/715,103, filed on Aug. 6, 2018.

(51) Int. Cl. A47J 31/52; A47J 31/42; A47J 31/06; A23F 5/26; A47J 31/44

(52) U.S. Cl. CPC A47J 31/52; A47J 31/42; A47J 31/446; A23F 5/26; A47J 31/06

(57) ABSTRACT

System and methods according to the present invention provide for an automated coffee brewing system, the automated coffee brewing system may comprise a system cavity which comprises at least one of a bean storage cavity, grinding assembly, brewing assembly, housing, water heating assembly, a controller, at least one sensing unit, a selection control, and a pouring unit providing the ability to produce at least one of bean-to-cup coffee and multi-serving container coffee, further a method operating at least one of a first embodiment of the automated coffee brewing system, a second embodiment of the automated coffee brewing system, and a third embodiment of the automated coffee brewing system is provided, and a method of operating a fourth embodiment of the automated coffee brewing system is provided.

### RELATED APPLICATIONS

This application claims the benefit of provisional application Ser. No. 62/715,103 filed 6 Aug. 2018.

### BACKGROUND OF THE INVENTION

The present invention is directed generally to coffee brewing systems, and more specifically to liquid coffee storage and used coffee bean disposal within the coffee brewing systems.

Coffee brewing systems are generally known in the art. Coffee brewing systems may be designed for personal use and/or commercial uses. Commercial use coffee brewing systems contain bean storage containers, a bean grinding assembly, a brewing assembly. The bean storage containers provide the coffee beans to the bean grinding assembly, where the coffee beans are ground in order to brew liquid coffee. The ground coffee beans proceed to a brewing assembly. The brewing assembly in the prior art may contain a brewing basket in which a filter paper is placed. The ground coffee beans are placed over the filter paper which is in the brewing basket. Water of a temperature is distributed over the ground coffee beans. Liquid coffee drips from a second side of the filter paper. In other prior art inventions, a continuous filter paper is employed wherein the ground coffee beans are poured onto of the continuous filter paper. Water of a temperature is distributed over the ground coffee beans. Liquid coffee drips from a second side of the continuous filter paper. The continuous filter paper advances removing the used coffee grounds and providing a substantially clean section of filter paper for subsequent brewing.

In the prior art, the liquid coffee is poured into a single cup or a multi-serving container. The pouring of a single cup or serving of liquid coffee is known as bean-to-cup production. The bean-to-cup production is limited by the fact that only a single serving of liquid coffee is dispersed at any one time. The multi-serving containers are traditionally carafes. The carafes require removal of any excess liquid coffee before production of a new batch of coffee infused water. Thus, a potential exists for waste due to the amount of liquid coffee which needs to be thrown out in order to make a new batch of liquid coffee.

Once a batch of liquid coffee is created, whether bean-to-cup or for multi-serving containers, the ground coffee beans employed require removal. Where a brewing basket employed, an individual is required to change the coffee filter and dispense of the used coffee grounds. As a result, an operator is required to interact with the system every time a new batch of liquid coffee is brewed in order to ensure a clean filter paper is available and the used coffee beans are removed.

Further the prior art systems provide one of a multi-serving container option or a bean-to-cup option. The prior art systems do not provide both options.

A need exists for an automated coffee brewing system with the capability of automatically determining when additional amounts of liquid coffee are required to be produced.

A need exists for an automated coffee brewing system providing for efficient removal of used coffee beans from the automated coffee brewing system.

A need exists for an automated coffee brewing system requiring minimal operation by operators.

A need exists for an automated coffee brewing system which eliminates waste liquid coffee.

A need exists for a method of operation of an automated coffee brewing system which reduces operation by operators.

### SUMMARY OF THE INVENTION

The present invention is directed generally to coffee brewing systems, and more specifically to liquid coffee storage and used coffee bean disposal within the coffee brewing systems.

The invention is to an automated coffee brewing system, comprising: a first end and an oppositely disposed second end, which define a system cavity; the system cavity providing for at Least one of a bean storage cavity, a grinding assembly, a brewing assembly, and a filter assembly; the bean storage cavity in close communication with the first end; the bean storage cavity in communication with the grinding assembly; the grinding assembly in communication with the brewing assembly; the brewing assembly in communication with the filter assembly, wherein a predetermined amount of coffee beans is in removable communication with the filter assembly; the filter assembly comprising a first spool, a second spool and a filter paper; and the filter paper transferrable between the first spool and the second spool, wherein the filter paper advances in at least one of a first direction and a second direction.

The invention is further to a method of operating an automated coffee brewing system, comprising: measuring a first amount of a liquid coffee within a housing; sending a measurement data to a controller; computing a second amount of liquid coffee to be produced, wherein applying the measurement data; sending a signal to a bean storage activity, wherein requesting the bean storage cavity deposit a specified amount of coffee beans; and repeating the measuring, sending, computing and sending for depositing steps.

The first embodiment of the automated coffee brewing system comprises a first end and an oppositely disposed second end, wherein the first end and the second end are separated by a first side and a second side. The first end and the second end alternatively may be separated by more than two sides. The combination of the first end, the second end, the first side, the second side, and any additional sides, creates a system cavity. It is note the first side and second side are at least substantially opposed from one another.

The system cavity comprises a bean storage cavity, grinding assembly, brewing assembly (at least one of a brewing assembly first embodiment, a brewing assembly second embodiment, and a brewing assembly third embodiment), housing, water heating assembly, a controller, and at least one sensing unit in communication to create liquid coffee. A bean storage cavity second end opening (not illustrated in the figures) opens into the grinding assembly. Wherein upon commend from the controller, a predetermined amount of coffee beans are deposited into the grinding assembly. The grinding assembly, upon command from the controller, provides for grinding of the coffee beans into ground coffee beans (not illustrated in the figures). The grinding assembly has a grinding assembly opening (not illustrated in the figures), opposite the bean storage cavity, which opens into the brewing assembly.

The brewing assembly comprises a brewing assembly cavity in communication with a filter assembly. The filter assembly comprises a first embodiment first spool cavity, a first embodiment second spool cavity, a first spool, a second spool, and a filter paper. The first embodiment first spool cavity is positioned in direct communication with brewing assembly second side. Further, the first embodiment first spool cavity is in close proximity to the second side. The first embodiment second spool cavity is positioned in direct communication with brewing assembly first side. Further, the first embodiment second spool cavity is in close proximity to the first side. The first embodiment, first spool cavity houses a first spool, wherein the first spool is in rotating communication with first embodiment first spool cavity perimeter such that the first spool is rotatable towards at least one of the first side and the second side. The first embodiment second spool cavity houses a second spool, wherein the second spool is in rotating communication with first embodiment second spool cavity perimeter such that the second spool is rotatable towards at least one of the first side and the second side.

Preferably, a spool of filter paper is placed on the first spool, and placed in rotatable communication with the second spool. The filter paper advances at least one of a first direction and a second direction upon commend from the controller. In operation grinding assembly deposits the ground coffee beans onto the filter paper along the distance.

The water heating assembly is in communication with the brewing assembly allowing depositing of water into the brewing assembly cavity and over the ground coffee beans in communication with the filter paper. The communication of the water and ground coffee beans creates liquid coffee. The liquid coffee filters through the filter paper via gravity or a form of suction towards a brewing assembly second end. The brewing assembly second end comprises at least one first embodiment, of a port, wherein the liquid coffee is transferred from the brewing assembly and into the housing.

Following completion of brewing the batch of coffee the filter assembly advances the filter paper in either the first direction or the second direction. The used ground coffee beans are deposited into at least one of the first embodiment first spool cavity and the first embodiment second spool cavity. Therefore, an operator need not address the second embodiment of the automated coffee brewing system at a high frequency in order to remove used ground coffee beans.

A first embodiment of the pouring unit is in communication with a housing cavity perimeter and provides for withdrawing of liquid coffee from the housing cavity.

An at least one sensing unit and the controller are housed with the system cavity. The combination of the at least one sensing unit, controller, the bean storage cavity, grinding assembly, brewing assembly, housing and water heating assembly allow for continued brewing of liquid coffee without the need for throwing away excess liquid coffee due to excess liquid coffee in a housing when a subsequent batch of liquid coffee is brewed.

The second embodiment of the automated coffee brewing system further incorporates a second embodiment first spool cavity and a second embodiment second spool cavity. Wherein a used grounds container is housed in at least one of the second embodiment first spool cavity and the second embodiment second spool cavity.

A third embodiment of the automated coffee brewing system incorporates a third embodiment first spool cavity and a third embodiment second spool cavity. A third embodiment first spool cavity incorporates at least one of a third embodiment, of the first spool cavity first side and a third embodiment of the first spool cavity second side. At least one of the third embodiment of the first spool cavity first side and the third embodiment of the first spool cavity second side is in communication with a first evacuation chamber. The first evacuation chamber is in communication with a second evacuation chamber. The second evacuation is in communication with external ports, wherein the used ground coffee beans travel through the from third embodiment first spool cavity, through the first evacuation chamber, through the second evacuation chamber, and into an external ports for removal of the used ground coffee beans.

A fourth embodiment of the automated coffee brewing system comprises at least one second embodiment of a port, wherein the liquid coffee is transferred from the brewing assembly, through a port nozzle of at least one of the at least one second embodiment of the port, into a tubing, and into a second embodiment of the pouring unit.

A selection control is preferably in removable communication with at least one of the first side and the second side. The selection control provides for the operator to select between bean-to-cup and mass production of liquid coffee. The selection control is in communication with the at least one sensing unit and the controller to provide for the operator to select between bean-to-cup and multi-serving container production of liquid coffee.

Therefore, an operator need not address the fourth embodiment of the automated coffee brewing system at a high frequency in order to remove used ground coffee beans.

A method of operation for at least one of the first embodiment of the automated coffee brewing system, the second embodiment of the automated coffee brewing system, and the third embodiment of the automated coffee brewing system is described. An at least one sensing unit sends measurement data to a controller on the amount of liquid coffee in a housing. Using the predetermined parameters, the controller computes the data and determines whether more liquid coffee is required to be produced.

Where no coffee is required to be produced, the controller waits a specified period of time and sends a command to the at least one sensing unit to take data. The data acquisition of the at least one sensing unit and the computation of the controller continues indefinitely.

During the data acquisition and computation process, where the controller determines the production of addition liquid coffee is required, liquid coffee is produced. The data acquisition of the at least one sensing unit and the computation of the controller continues indefinitely. The filter paper of the filter paper assembly advances depositing the used ground coffee beans into at least one of the first spool cavity and second spool cavity, and providing for a clean filter paper section for subsequent brewing of liquid coffee. Used coffee beans are removed from the automated coffee brewing system (removal may be manually or by a mechanized system).

A method of operation for the fourth embodiment of the automated coffee brewing system is described. Operator chooses multi-serving container or bean-to-cup option of the automated coffee brewing system. Where a multi-serving container option is selected, the at least one sensing unit sends measurement data to the controller on the amount of liquid coffee in the housing. Using the predetermined parameters, the controller computes the data and determines whether more liquid coffee is required to be produced.

Where no coffee is required to be produced, the controller waits a specified period of time and sends a command to the at least one sensing unit to take data. The data acquisition of the at least one sensing unit and the computation of the controller continues indefinitely.

During the data acquisition and computation process, where the controller determines the production of addition liquid coffee is required, liquid coffee is produced. The data acquisition of the at least one sensing unit and the computation of the controller continues indefinitely. The filter paper of the filter paper assembly advances depositing the used ground coffee beans into the first spool cavity or second spool cavity and providing for a clean filter paper section for subsequent brewing of liquid coffee. Used coffee beans are removed from the automated coffee brewing system.

Where a bean-to-cup option is selected at step, liquid coffee filters through the filter paper and through at least one second embodiment of the ports allowing for distribution of a single serving of liquid coffee.

The combination of at least one of the at least one sensing unit, the controller, and the selection control provide for minimal waste of liquid coffee, because the automated brewing system determines the amount of liquid coffee required to be made and an operator need not throw out excess coffee when a new batch of liquid coffee is produced.

The invention provides an intended benefit for an automated coffee brewing system with the capability of automatically determining when additional amounts of liquid coffee are required to be produced.

The invention provides an intended benefit for an automated coffee brewing system providing for efficient removal of used coffee beans from the automated coffee brewing system.

The invention provides an intended benefit for an automated coffee brewing system requiring minimal operation by operators.

The invention provides an intended benefit for an automated coffee brewing system which eliminates waste liquid coffee.

The invention provides an intended benefit for an automated coffee brewing system which reduces operation by operators.

### BRIEF DESCRIPTION OF THE DRAWINGS

FIG. 1 is a side view of a first embodiment of an automated coffee brewing system.

FIG. 2 is a side view of the first embodiment of the automated coffee brewing system.

FIG. 3 is a side of a second embodiment of the automated coffee brewing system.

FIG. 4 is a side view of a third embodiment of the automated coffee brewing system.

FIG. 5 is a side view of a fourth embodiment of the automated coffee brewing system.

FIG. 6 is a method of operation of at least one of the first embodiment of the automated coffee brewing system, the second embodiment of the automated coffee brewing system, the third embodiment of the automated coffee brewing system, and fourth embodiment of the automated coffee brewing system.

FIG. 7 is a method of operation of the fourth embodiment of the automated coffee brewing system.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

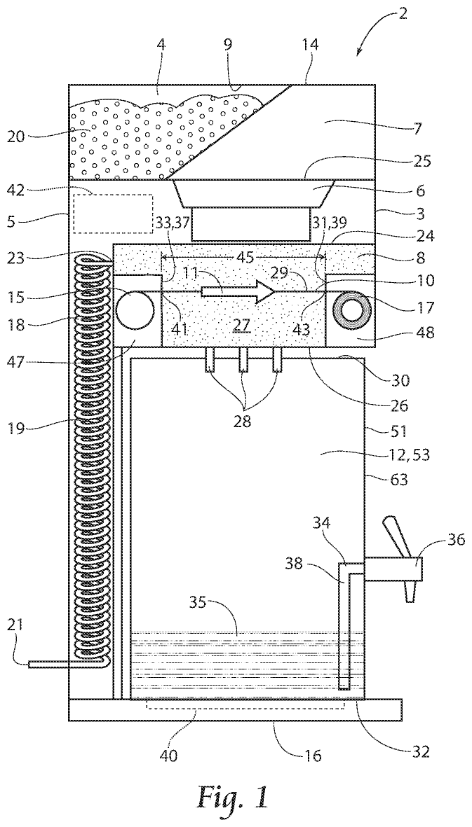

With attention to FIG. 1, a first embodiment of the automated coffee brewing system 2 is described. The first embodiment of the automated coffee brewing system 2 comprises a first end 14 and an oppositely disposed second end 16, wherein the first end 14 and the second end are separated by a first side 3 and a second side 5. The first end 14 and the second end 16 alternatively may be separated by more than two sides. The combination of the first end 14, the second end 16, the first side 3, the second side 5, and any additional sides, creates a system cavity 7. It is note the first side 3 and second side 5 are at least substantially opposed from one another.

The system cavity 7 comprises a bean storage cavity 4, grinding assembly 6, brewing assembly (at least one of a brewing assembly first embodiment 8, brewing assembly second embodiment 108, and a brewing assembly second embodiment 208), housing 12, water heating assembly 18, a controller 42, and at least one sensing unit 40 in communication to create liquid coffee 35. A bean storage cavity first end 9 is in at least substantially close communication with the first end 14. A bean storage cavity-second end 25 is at least substantially oppositely opposed to the bean storage cavity first end 9 and extends into the system cavity 7 towards the second end 16. The bean storage cavity 4 houses coffee beans 20 prior to processing of the coffee beans 20 into liquid coffee 35. The bean storage cavity second end 25 comprises an opening (not illustrated in the figures) wherein the opening is closed an opened through commands from a controller 42 within the system cavity 7. The bean storage cavity second end 25 opening (not illustrated in the figures) opens into the grinding assembly 6. Wherein upon command from the controller 42, a predetermined amount of coffee beans 20 are deposited into the grinding assembly 6. The grinding assembly 6, upon command from the controller 42, provides for grinding of the coffee beans 20 into ground coffee beans (not illustrated in the figures). The grinding assembly 6 has a grinding assembly opening (not illustrated in the figures), opposite the bean storage cavity 4, which opens into the brewing assembly 8.

The brewing assembly 8 comprises a brewing assembly cavity 27 in communication with a filter assembly 10. The filter assembly comprises a first embodiment first spool cavity 47, a first embodiment, second spool cavity 48, a first spool 15, a second spool 17, and a filter paper 29. The first embodiment first spool cavity 47 is positioned in direct communication with brewing assembly second side 33. Further, the first, embodiment, first spool cavity 47 is in close proximity to the second side 5. The first embodiment second spool cavity 48 is positioned in direct communication with brewing assembly first side 31. Further, the first embodiment second spool cavity 48 is in close proximity to the first side 3. The first embodiment first spool cavity 47 houses a first spool 15, wherein the first spool 15 is in rotating communication with first embodiment first spool cavity perimeter 37 such that the first spool 15 is rotatable towards at least one of the first side 3 and the second side 5. The first embodiment second spool cavity 48 houses a second spool 17, wherein the second spool 17 is in rotating communication with first embodiment second spool cavity perimeter 39 such that the second spool 17 is rotatable towards at least one of the first side 3 and the second side 5. A brewing cavity/first embodiment first spool cavity opening 41 provides access between the brewing assembly cavity 27 and the first embodiment first spool cavity 47. A brewing cavity/first embodiment second spool cavity opening 43 provides access between the brewing assembly cavity 27 and the first embodiment second spool cavity 48. The brewing cavity/first embodiment first spool cavity opening 41 and the brewing cavity/first embodiment second spool cavity opening 43 are in line-of-sight communication with one another and separated by a distance 45.

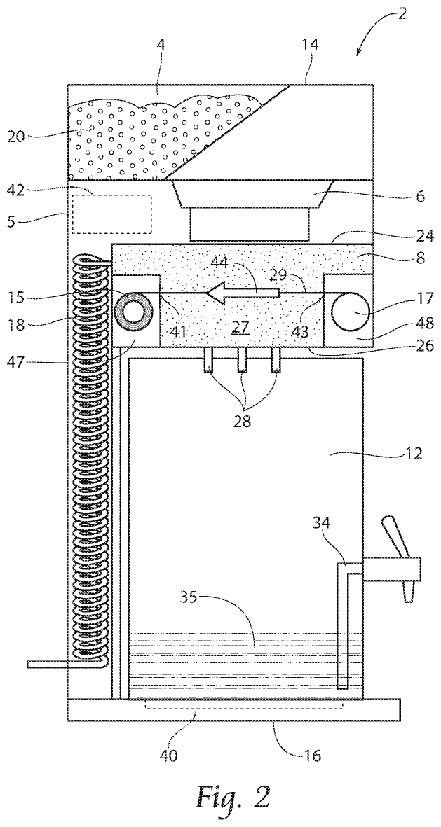

Preferably, a spool of filter paper 29 is placed on the first spool 15, the filter paper 29 is fed through the brewing cavity/first embodiment first spool cavity opening 41, across the distance 45, through the brewing cavity/first embodiment second spool cavity opening 43, and placed in rotatable communication with the second spool 17. The filter paper 29 advances a first direction 11 upon commend from the controller 42. In operation grinding assembly 6, having a grinding assembly opening (not illustrated in the figures) that opens into the brewing assembly 8 via the brewing assembly first end 24, provides for depositing the ground coffee beans (not illustrated in the figures) onto the filter paper along the distance 45. Alternatively, as illustrated in FIG. 2, a spool of filter paper 29 is placed on the second spool 17, the filter paper 29 is fed through the brewing cavity/first embodiment second spool cavity opening 43, across the distance 45, through the brewing cavity/first embodiment first spool cavity opening 41, and placed in rotatable communication with the first spool 15. The filter paper 29 advances a second direction 44 upon commend from the controller 42. In operation grinding assembly 6, having a grinding assembly opening (not illustrated in the figures) that opens into the brewing assembly 8 via the brewing assembly first end 24, provides for depositing the ground coffee beans (not illustrated in the figures) onto the filter paper along the distance 45.

As illustrated in FIG. 1, The water heating assembly 18 is in communication with the brewing assembly allowing depositing of water into the brewing assembly cavity 27 and over the ground coffee beans (not illustrated in the figures) in communication with the filter paper 29 along the distance 45. The communication of the water and ground coffee beans (not illustrated in the figures) creates liquid coffee 35. The liquid coffee filters through the filter paper 29 via gravity or a form of suction towards a brewing assembly second end first embodiment 26. The brewing assembly second end 26 comprises at least one first embodiment of a port 28, wherein the liquid coffee is transferred from the brewing assembly 8 and into the housing 12. It is observed the water heating assembly 18 comprises at least one coil 19 housed in between an in port and an outlet port. The in port provides entry of water into the water heating assembly 18 from an external source. The water proceeds through the at least one coil 19 and towards the outlet port 23. The outlet port 23 provides for depositing of the water into the brewing assembly 8.

Following completion of brewing the batch of coffee the filter assembly 10 advances the filter paper 29 in either the first direction 11 or the second direction 44. In the event the filter paper is advanced in the first direction 11, the used ground coffee beans (not illustrated in the figures) are deposited into the first embodiment second spool cavity 48. In the event the filter paper is advanced in the second direction 44, the used ground coffee beans (not illustrated in the figures) are deposited into the first embodiment first spool cavity 47. Depositing of the used coffee beans in at least one of the first embodiment first spool cavity 47 and the first embodiment second spool cavity 48 allows for storage of the used ground coffee beans (not illustrated in the figures). Therefore, an operator need not address the second embodiment of the automated coffee brewing system 2 at a high frequency in order to remove used ground coffee beans (not illustrated in the figures).

The housing 12 comprises a housing first end 30, housing second end 32, and housing side wall assembly 51. The housing first end 30 and housing second end 32 are oppositely opposed and separated by the housing side wall assembly 51. The communication of the housing first end 30, housing second end 32 and the housing side wall assembly 51 provides for a housing cavity 53 in which a housing cavity perimeter 63 is defined by the communication of the housing first end 30, housing second end 32 and the housing side wall assembly 51. The at least one first embodiment of the port 28 is in communication with the housing first end 30, wherein liquid coffee 35 is deposited into the housing cavity 53. A first embodiment of the pouring unit 34 is in communication with the housing cavity perimeter 63 and provides for withdrawing of liquid coffee from the housing cavity 12. The first embodiment of the pouring unit 34 comprises a spigot 36, outside the housing cavity 53, and a first embodiment of the interior collection assembly 38, positioned within the housing collection assembly. The spigot 36 and the first embodiment of the interior collection assembly 38 are in communication to allow for removal of liquid coffee 35 from the housing 12.

An at least one sensing unit 40 and the controller 42 are housed with the system cavity 7. The at least one sensing unit 40 is preferably in direct communication with the housing second end 32. Alternatively, the at least one sensing unit 40 may be in communication with at least one of the housing second end 32 and the housing side wail assembly 51. Preferably, the at least one sensing unit 40 measures the weight of the combination of the housing 12 and liquid coffee 35 within the housing 12. Alternatively, the at least one sensing unit 40 measures the volume of liquid coffee 35 within the housing 12. Measurement of the volume may be performed by a measurement buoy, measurement indicator which measures the height of the liquid coffee 35 in the housing or a known method of measuring volume in the art. The measurement data is sent from the at least one sensing unit 40 to the controller 42. The controller 42 applies a set of predetermined parameters to the measurement data received from the at least one sensing unit 40. Using the predetermined parameters the controller 42 calculates whether more liquid coffee 35 is required to be brewed. Further, the controller determines the amount of liquid coffee 35 which required to be brewed. The controller 42 commands the bean storage cavity 4 to release a calculated amount of coffee beans 20, based upon the amount of liquid coffee 35 that is calculated to be required to be brewed based upon the measurement data. Further, the controller commends and monitors the brewing assembly, housing, and water heating assembly of the first embodiment of the automated coffee brewing system 2. The combination of the at least one sensing unit 40, controller 42, the bean storage cavity 4, grinding assembly 6, brewing assembly 8, housing 12 and water heating assembly 18 allow for continued brewing of liquid coffee without the need for throwing away excess liquid coffee 35 due to excess liquid coffee 35 in a housing when a subsequent batch of liquid coffee 35 is brewed.

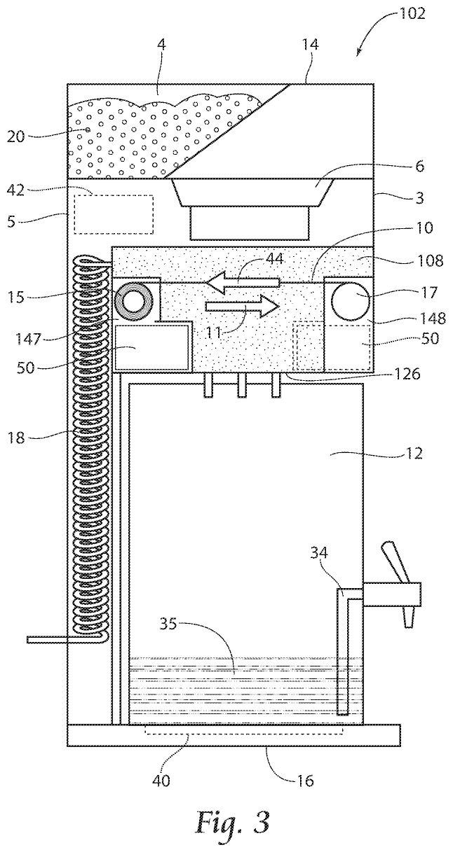

With attention to FIG. 3, a second embodiment of the automated coffee brewing system 102. It is observed that at least one element of the invention first embodiment of the automated coffee brewing system 2 may be in cooperation with at least one element of the invention second embodiment of the automated coffee brewing system 102. Further, the second embodiment of the automated coffee brewing system 102 incorporates a second embodiment first spool cavity 147, a second embodiment second spool cavity 148, and a brewing assembly second embodiment 108 having a brewing assembly second end second embodiment 126. Wherein a used grounds container 50 is removably housed in the second embodiment first spool cavity 147. Wherein a used grounds container 50 is removably housed in the second embodiment second spool cavity 148. Following completion of brewing the batch of coffee the filter assembly 10 advances the filter paper 29 in either the first direction 11 or the second direction 44. In the event the filter paper is advanced in the first direction 11, the used ground coffee beans (not illustrated in the figures) are deposited into the used grounds container 50 which is removably housed in the second embodiment second spool cavity 148. In the event the filter paper is advanced in the second direction 44, the used ground coffee beans (not illustrated in the figures) are deposited into the used grounds container 50 is removably housed in the second embodiment first spool cavity 147. Depositing of the used coffee beans in at least one of the used grounds container 50 is removably housed in the second embodiment first spool cavity 147 and the used grounds container 50 which is removably housed in the second embodiment second spool cavity 148 allows for removable storage of the used ground coffee beans (not illustrated in the figures). Therefore, an operator need not address the second embodiment of the automated coffee brewing system 2 at a high frequency in order to remove used ground coffee beans (not illustrated in the figures).

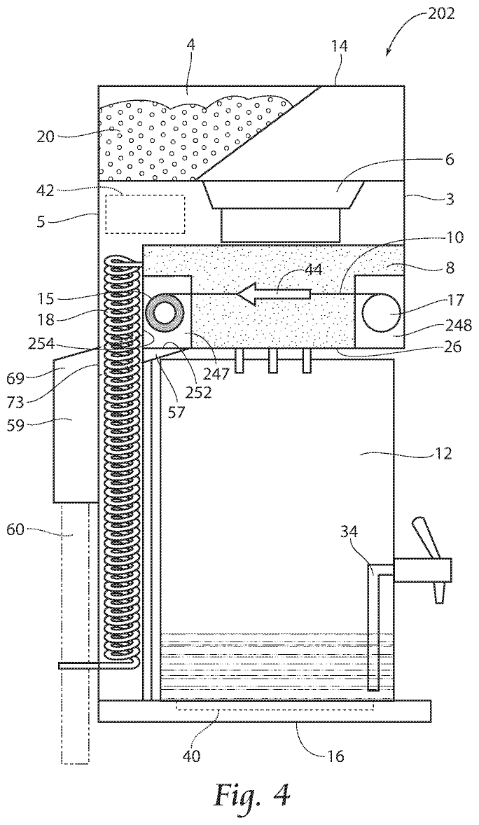

With attention to FIG. 4, a third embodiment of the automated coffee brewing system 202 is illustrated. It is observed that at least one element of the invention first embodiment of the automated coffee brewing system 2 may be in cooperation with at least one element of the invention third embodiment of the automated coffee brewing system 202. It is observed that at least one element of the invention second embodiment of the automated coffee brewing system 102 may be in cooperation with at least one element of the invention third embodiment of the automated coffee brewing system 202. Further, the third embodiment of the automated coffee brewing system 202 incorporates a third embodiment first spool cavity 247 and a third embodiment second spool cavity 248. A third embodiment first spool cavity 247 incorporates at least one of a third embodiment of the first spool cavity first side 252 and a third embodiment of the first spool cavity second side 254. At least one of the third embodiment of the first spool cavity first side 252 and the third embodiment of the first spool cavity second side 254 is in communication with a first evacuation chamber 57. In the event the filter paper is advanced in the second direction 44, the used ground coffee beans (not illustrated in the figures) are deposited into the third embodiment first spool cavity 247. The used ground coffee beans proceed towards and into the first evacuation chamber 57. The first evacuation chamber is preferably in removable communication with the third embodiment first spool cavity 247. Alternatively, the first evacuation chamber may be in fixed communication with the third embodiment first spool cavity 247. The procession of the used ground coffee beans (not illustrated in the figures) into and through the first evacuation chamber 57 may be advanced by mechanical motion. Alternatively, the procession of the used ground coffee beans (not illustrated in the figures) into and through the first evacuation chamber 57 may be advanced by gravity. Alternatively, the procession of the used ground coffee beans (not illustrated in the figures) into and through the first evacuation chamber 57 may be advanced by a combination of mechanical motion and gravity. A first evacuation chamber second end 73 is preferably in removable communication with a second evacuation chamber. Alternatively, the first evacuation chamber second end 73 may be in fixed communication with a second evacuation chamber 59. The procession of the used ground coffee beans (not illustrated in the figures) into and through the second evacuation chamber 59 may be advanced by mechanical motion. Alternatively, the procession of the used ground coffee beans (not illustrated in the figures) into and through the second evacuation chamber 59 may be advanced by gravity. Alternatively, the procession of the used ground coffee beans (not illustrated in the figures) into and through the second evacuation chamber 59 may be advanced by a combination of mechanical motion and gravity. The second evacuation is preferably in removable communication with external ports, wherein the used ground coffee beans (not illustrated in the figures) travel into the external ports 60. Alternatively, the second evacuation may be in removable communication with external ports, wherein the used ground coffee beans (not illustrated in the figures) travel into the external ports 60.

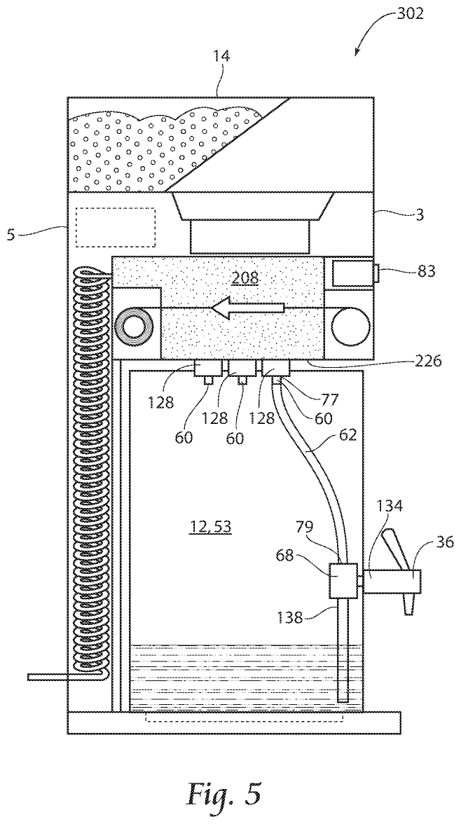

With attention to FIG. 5, a fourth embodiment of the automated coffee brewing system is illustrated. It is observed that at least one element of the invention first embodiment of the automated coffee brewing system 2 may be in cooperation with at least one element of the invention fourth embodiment of the automated coffee brewing system 302. It is observed that at least one element of the invention second embodiment of the automated coffee brewing system 102 may be in cooperation with at least one element of the invention fourth embodiment of the automated coffee brewing system 302. It is observed that at least one element of the invention third embodiment of the automated coffee brewing system 202 may be in cooperation with at least one element of the invention fourth embodiment of the automated coffee brewing system 302. In the invention fourth embodiment of the automated coffee brewing system 302, the brewing assembly second end third embodiment 226 comprises at least one second embodiment of the port 128, wherein the liquid coffee is transferred from the brewing assembly third embodiment 208 and into the housing 12. The at least one second embodiment of the port 128 having a port nozzle extending in to the housing cavity 53 and opposite the brewing assembly third embodiment 208. The at least second embodiment of the one port 128 is in communication with the housing first end 30, wherein liquid coffee 35 is deposited into the housing cavity 53. A port nozzle 60 of at least one of the at least one second embodiment of the port 128 is in removable communication with a tubing 62 at a tubing first end 77. The tubing 62 is defined by the tubing first end 77 and an oppositely opposed tubing second end 79.

The tubing second end 79 is in communication with a second embodiment, of the pouring unit 134. A second embodiment of the pouring unit 134 is in communication with the housing cavity perimeter 63 and provides for withdrawing of liquid coffee from the housing cavity 53. The second embodiment of the pouring unit 134 comprises a spigot 36, outside the housing cavity 53, and a second embodiment of the interior collection assembly 138 and manifold 68, positioned within the housing collection assembly. The second embodiment of the interior collection assembly 138 and manifold 68 are preferably in removable communication. Alternatively, the second embodiment of the interior collection assembly 138 and manifold 68 may be in fixed communication. The tubing second end 79 is in removable communication with the manifold 68. Alternatively, the tubing second end 79 is in fixed communication with the manifold. The at least one second embodiment of the port 128, the tubing 62, the manifold 68 and the spigot work together to allow for removal of liquid coffee 35 in a bean-to-cup format where a single cup of liquid coffee 35 is produced by the end user. Additionally, the spigot 36, the second embodiment of the interior collection assembly 138, and the manifold 68 are in communication to allow for removal of liquid coffee 35 in a multi-serving container format.

A selection control 83 is preferably in removable communication with at least one of the first side 3 and the second side 5. The selection control 83 provides for the operator to select between bean-to-cup and mass production of liquid coffee 35. The selection control 83 is in communication with the at least one sensing unit 40 and the controller 42 to provide for the operator to select between bean-to-cup and multi-serving container production of liquid coffee 35.

Therefore, an operator need not address the fourth embodiment of the automated coffee brewing system 302 at a high frequency in order to remove used ground coffee beans (not illustrated in the figures).

Alternatively, at least one of the first embodiment of the automated coffee brewing system 2, the second embodiment of the automated coffee brewing system 102, the third embodiment of the automated coffee brewing system 202 and the fourth embodiment of the automated coffee brewing system 302 may have two housings 12, wherein the two housings 12 are in fluid communication. Further, wherein in at least one housing may provide for brewing of liquid coffee 35 and at least one housing may provide for storage of liquid coffee 35. It is further observed the two housings 12 may have a rinsing feature, wherein the housing cavity 53 is cleaned following a completion of brewing and storage of liquid coffee.

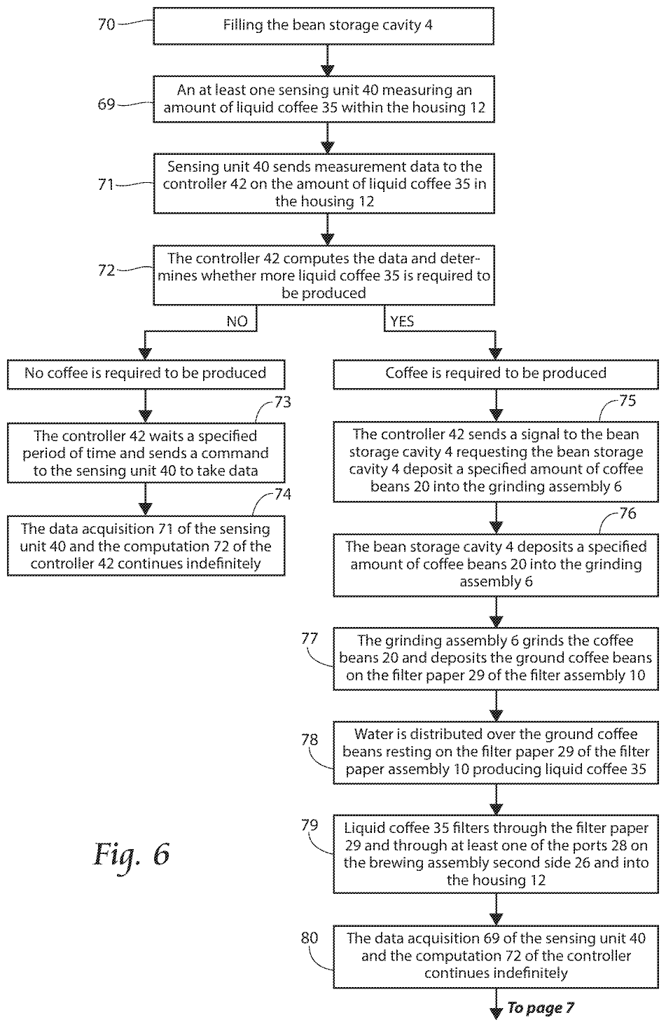

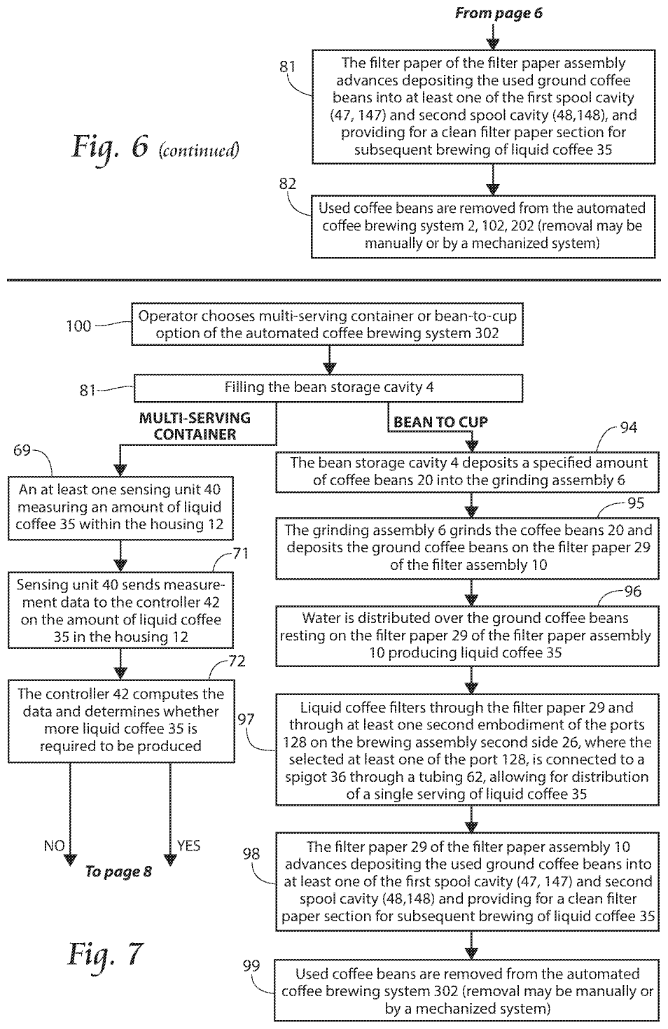

With attention to FIG. 6, a method of operation for at least one of the first embodiment of the automated coffee brewing system 2, the second embodiment of the automated coffee brewing system 102, and the third embodiment, of the automated coffee brewing system 202 is described. An operator, mechanically or manually, fills the bean storage cavity 4, 70. An at least one sensing unit 40 measuring an amount of liquid coffee 35 within the housing 12, 69. The at least one sensing unit 40 sends measurement data to a controller 42 on the amount of liquid coffee 35 in a housing 12, 71. Using the predetermined parameters, the controller 42 computes the data and determines at least one of whether more liquid coffee 35 is required to be produced and the amount of liquid coffee 35 to be produced, 72.

Where no coffee is required to be produced, the controller 42 waits a specified period of time and sends a command to the at least one sensing unit 40 to take data, 73. The data acquisition 71 of the at least one sensing unit 40 and the computation 72 of the controller continues indefinitely, 74.

During the data acquisition 71 and computation 72 process, where the controller 42 determines the production of addition liquid coffee 35 is required, the controller 42 sends a signal to the bean storage cavity 4 requesting the bean storage cavity deposit a specified amount of coffee beans into the grinding assembly 6, 75. The bean storage cavity 4 deposits a specified amount of coffee beans into the grinding assembly 6, 76. The grinding assembly 6 grinds the coffee beans 20 and deposits the ground coffee beans (not illustrated in the figures) on the filter paper 29 of the filter assembly 10 within a brewing assembly 8, 77. Water is distributed over the ground coffee beans (not illustrated in the figures) resting on the filter paper 29 of the filter paper assembly 10 producing liquid coffee 35, 78. Liquid coffee 35 filters through the filter paper 29 and through the at least one first embodiment of the port 28 on the brewing assembly second side 26 and into the housing 12, 79. The data acquisition 69 of the at least one sensing unit 40 and the computation 72 of the controller 42 continues indefinitely, 80. The filter paper 29 of the filter paper assembly 10 advances depositing the used ground coffee beans (not illustrated in the figures) into at least one of the first spool cavity (47, 147) and second spool cavity (48,148), and providing for a clean filter paper section for subsequent brewing of liquid coffee 35, 81. Used coffee beans are removed from the automated coffee brewing system (2, 102, 202) (removal may be manually or by a mechanized system).

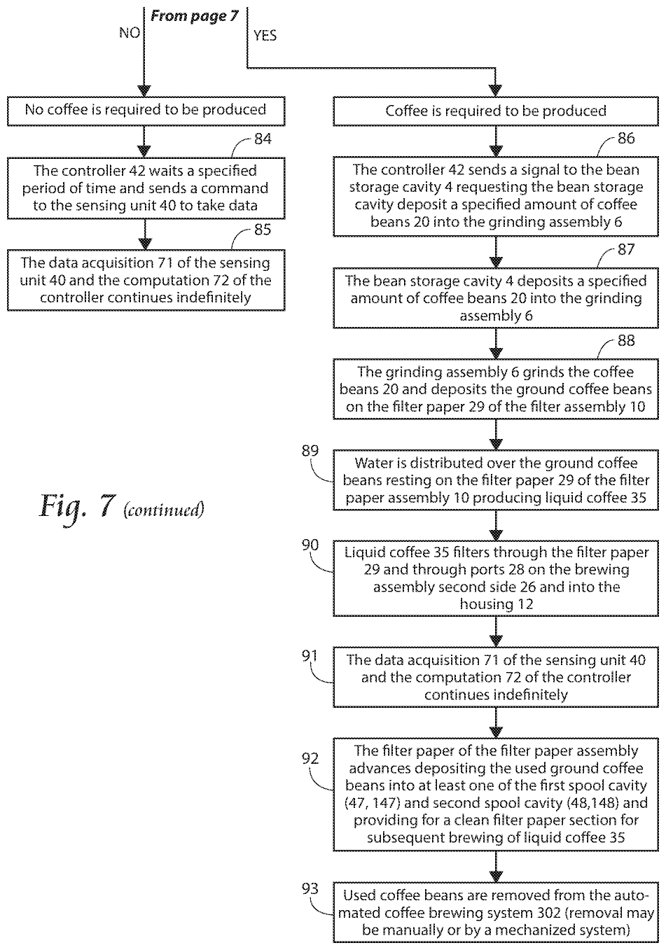

With attention to FIG. 7, a method of operation for the fourth embodiment of the automated coffee brewing system 302 is described. Operator chooses multi-serving container or bean-to-cup option of the automated coffee brewing system 302, 100. An operator, mechanically or manually, fills the bean storage cavity 4, 81.

Where a multi-serving container option is selected, an at least one sensing unit 40 measuring an amount of liquid coffee 35 within the housing 12, 69. the at least one sensing unit 40 sends measurement data to the controller 42 on the amount of liquid coffee 35 in the housing 12, 71. Using the predetermined parameters, the controller 42 computes the data and determines at least one of whether more liquid coffee 35 is required to be produced and the amount of liquid coffee 35 to be produced, 72.

Where no coffee is required to be produced, the controller 42 waits a specified period of time and sends a command to the at least one sensing unit 40 to take data, 84. The data acquisition 69 of the at least one sensing unit 40 and the computation 72 of the controller continues indefinitely, 85.

During the data acquisition 82 and computation 83 process, where the controller 42 determines the production of addition liquid coffee 35 is required, the controller 42 sends a signal to the bean storage cavity 4 requesting the bean storage cavity 4 deposit a specified amount of coffee beans 20 into the grinding assembly 6, 86. The bean storage cavity 4 deposits a specified amount of coffee beans 20 into the grinding assembly 6, 87. The grinding assembly 6 grinds the coffee beans 20 and deposits the ground coffee beans (not illustrated in the figures) on the filter paper 29 of the filter assembly 10, 88. Water is distributed over the ground coffee beans (not illustrated in the figures) resting on the filter paper 29 of the filter paper assembly 10 producing liquid coffee 35, 89. Liquid coffee 35 filters through the filter paper 29 and through the at least one first embodiment of the port 28 on the brewing assembly second side 26 and into the housing 12, 90. The data acquisition 69 of the at least one sensing unit 40 and the computation 72 of the controller 42 continues indefinitely, 91. The filter paper 29 of the filter paper assembly 10 advances depositing the used ground coffee beans (not illustrated in the figures) into the first spool cavity (47, 147) or second spool cavity (48,148) and providing for a clean filter paper section for subsequent brewing of liquid coffee 35, 92. Used coffee beans are removed from the automated coffee brewing system 302 (removal may be manually or by a mechanized system), 93.

Where a bean-to-cup option is selected at step 100, the bean storage cavity 4 deposits a specified amount of coffee beans into the grinding assembly 6, 94. The grinding assembly 6 grinds the coffee beans 20 and deposits the ground coffee beans on the filter paper 29 of the filter assembly 10, 95. Water is distributed over the ground coffee beans resting on the filter paper 29 of the filter paper assembly 10 producing liquid coffee 35, 96. Liquid coffee filters through the filter paper 29 and through at least one second embodiment of the ports 120 on the brewing assembly second side 26, where the selected at least one of the port 128, is connected to a spigot 36 through a tubing 62, allowing for distribution of a single serving of liquid coffee 35, 97. The filter paper 29 of the filter paper assembly 10 advances depositing the used ground coffee beans into at least one of the first spool cavity (47, 147) and second spool cavity (48,148) and providing for a clean filter paper section for subsequent brewing of liquid coffee 35, 98. Used coffee beans are removed from the automated coffee brewing system 302 (removal may be manually or by a mechanized system), 99.

The combination of at least one of the at least one sensing unit 40, the controller 42, and the selection control 83 provide for minimal waste of liquid coffee 35, because the automated brewing system (2, 102, 202, 302) determines the amount of liquid coffee 35 required to be made and an operator need not throw out excess coffee when a new batch of liquid coffee 35 is produced.

It is observed that at least one element of the method of operation for the fourth embodiment of the automated coffee brewing system 302 may be in cooperation with at least one element of the method of operation for at least one of the first embodiment of the automated coffee brewing system 2, the second embodiment of the automated coffee brewing system 102, and the third embodiment of the automated coffee brewing system 202.

It is observed that at least one element of the first embodiment first spool cavity 47 may be in cooperation with at least one element of the second embodiment first spool cavity 147.

It is observed that at least one element of the first embodiment first spool cavity 47 may be in cooperation with at least one element of the third embodiment first spool cavity 247.

It is observed that at Least one element of the second embodiment first spool cavity 147 may be in cooperation with at least one element of the third embodiment first spool cavity 247.

It is observed that at least one element of the first embodiment second spool cavity 48 may be in cooperation with at least one element of the second embodiment second spool cavity 148.

It is observed that at least one element of the first embodiment second spool cavity 48 may be in cooperation with at least one element of the third embodiment third spool cavity 248.

It is observed that at least one element of the second embodiment second spool cavity 248 may be in cooperation with at least one element of the third embodiment second spool cavity 248.

It is observed that at least one element of at least one first embodiment of the port 28 may be in cooperation with at least one element, of at least one second embodiment of the port 128.

It is observed that at least one element a first embodiment of the pouring unit 34 may be in cooperation with at least one element of a second embodiment of the pouring unit 134.

It is observed that at least one element of a first embodiment of the interior collection assembly 38 may be in cooperation with at least one element of a second embodiment of the interior collection assembly 138.

It is observed at least one element of brewing assembly first embodiment 8 is in cooperation with at least one element of brewing assembly second embodiment 108.

It is observed at least one element of brewing assembly first embodiment 8 is in cooperation with at least one element of brewing assembly brewing assembly third embodiment 208.

It is observed at least one element of brewing assembly second embodiment 108 is in cooperation with at least one element of brewing assembly brewing assembly third embodiment 208.

It is observed that at least one element of the brewing assembly second end first embodiment 26 may be in cooperation with at least one element of a brewing assembly second end second embodiment 126.

It is observed that at least one element of the brewing assembly second end first embodiment 26 may be in cooperation with at least one element of a brewing assembly second end third embodiment 226.

It is observed that at least one element of the brewing assembly second end second embodiment 126 may be in cooperation with at least one element of a brewing assembly second end third embodiment 226.

The invention provides an intended benefit for an automated coffee brewing system (2, 102, 202, 302) with the capability of automatically determining when additional amounts of liquid coffee are required to be produced.

The invention provides an intended benefit for an automated coffee brewing system (2, 102, 202, 302) providing for efficient removal of used coffee beans from the automated coffee brewing system.

The invention provides an intended benefit for an automated coffee brewing system (2, 102, 202, 302) requiring minimal operation by operators.

The invention provides an intended benefit for an automated coffee brewing system (2, 102, 202, 302) which eliminates waste liquid coffee.

The invention provides an intended benefit for an automated coffee brewing system (2, 102, 202, 302) which reduces operation by operators.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. An automated coffee brewing system, comprising:
a first end and an oppositely disposed second end, which define a system cavity;
said system cavity providing for at least one of a bean storage cavity, a grinding assembly, a brewing assembly, and a filter assembly;
said bean storage cavity in close communication with said first end;
said bean storage cavity in communication with said grinding assembly;
said grinding assembly in communication with said brewing assembly;
said brewing assembly in communication with said filter assembly, wherein a predetermined amount of coffee beans is in removable communication with said filter assembly;
said filter assembly comprising a first spool, a second spool and a filter paper; and
said filter paper transferrable between said first spool and said second spool, wherein said filter paper advances in at least one of a first direction and a second direction.

2. A method of operating an automated coffee brewing system, comprising:
measuring a first amount of a liquid coffee within a housing;
sending a measurement data to a controller;
computing a second amount of said liquid coffee to be produced, wherein applying said measurement data;
sending a signal to a bean storage cavity, wherein requesting said bean storage cavity deposit a specified amount of coffee beans; and
repeating said measuring, sending, computing and sending for depositing steps.
